(19) United States
(12) Patent Application Publication
(10) Pub. No.: US 2019/0384493 A1
(43) Pub. Date: Dec. 19, 2019

(54) METHOD, DEVICE, AND COMPUTER PROGRAM PROUCT FOR MANAGING VIRTUAL MACHINES

(71) Applicant: EMC IP Holding Company LLC, Hopkinton, MA (US)

(72) Inventors: Yun Zhang, Shanghai (CN); Ming Zhang, Shanghai (CN); Jingjing Guo, Shanghai (CN)

(21) Appl. No.: 16/147,806

(22) Filed: Sep. 30, 2018

(30) Foreign Application Priority Data
Jun. 15, 2018 (CN) 201810623970.5

(51) Int. Cl. G06F 3/06; G06F 9/455

(52) U.S. Cl. CPC G06F 3/065; G06F 3/0619; G06F 9/45533; G06F 3/067; G06F 3/0664

(57) ABSTRACT

Implementations of the present disclosure relate to a method, device and computer program product for managing a virtual machine. According to example implementations of the present disclosure, the method includes determining whether a property of a virtual machine meets a predefined rule, the predefined rule being used to select a to-be-backed-up virtual machine; in response to the property of the virtual machine meeting the predefined rule, determining an application client corresponding to an application in the virtual machine, the application client indicating characteristic information of the application in a backup system; and determining, based on the application client, a backup policy for the application to back up the application, the backup policy specifying an approach for backing up the application in the backup system.

### FIELD

Implementations of the present disclosure relate to management of a virtual machine (VM), and more specifically, to a method, device and computer program product for managing a virtual machine.

### BACKGROUND

A virtual machine management system comprises virtual machines used to run workloads for various businesses. A virtual machine might be destroyed because of, for example, a human operation error or a certain natural disaster. In this case, users hope that these virtual machines can be restored from a backup system as fast as possible, and provide services right after the restoration. However, traditional virtual machine management techniques fail to ensure the application consistency when backing up the virtual machines, so that the virtual machines cannot be immediately used after being restored.

### SUMMARY

Embodiments of the present disclosure provide a method, device and computer program product for managing a virtual machine.

One aspect of the present disclosure provides a method for managing a virtual machine. The method comprises: determining whether a property of a virtual machine meets a predefined rule, the predefined rule being used to select a to-be-backed-up virtual machine; in response to the property of the virtual machine meeting the predefined rule, determining an application client corresponding to an application in the virtual machine, the application client indicating characteristic information of the application in a backup system; and determining, based on the application client, a backup policy for the application to back up the application, the backup policy specifying an approach for backing up the application in the backup system.

One aspect of the present disclosure provides a device for managing a virtual machine. The device comprises at least one processing unit and at least one memory. The at least one memory is coupled to the at least one processing unit and stores instructions executed by the at least one processing unit. The instructions, when executed by the at least one processing unit, causes the device to perform a method, the method includes determining whether a property of a virtual machine meets a predefined rule, the predefined rule being used to select a to-be-backed-up virtual machine; in response to the property of the virtual machine meeting the predefined rule, determining an application client corresponding to an application in the virtual machine, the application client indicating characteristic information of the application in a backup system; and determining, based on the application client, a backup policy for the application to back up the application, the backup policy specifying an approach for backing up the application in the backup system.

One aspect of the present disclosure provides a computer program product. The computer program product is tangibly stored on a non-transient computer readable medium and comprises machine executable instructions. The machine executable instructions, when executed, cause a machine to implement a method according to any aspect of the present disclosure.

The Summary is to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

Through the following more detailed description of the example embodiments of the present disclosure with reference to the accompanying drawings, the above and other objectives, features, and advantages of the present disclosure will become more apparent, wherein the same reference sign usually refers to the same component in the example embodiments of the present disclosure.

FIG. 1 shows a schematic view of a traditional virtual machine management environment;

FIG. 2 shows a schematic view of an example of a virtual machine management environment where embodiments of the present disclosure may be implemented;

FIG. 3 shows a flowchart of an example of a method for managing a virtual machine according to embodiments of the present disclosure;

FIG. 4 shows a flowchart of another example of a method for managing a virtual machine according to embodiments of the present disclosure; and

FIG. 5 shows a schematic block diagram of an example device which is applicable to implement embodiments of the present disclosure.

Throughout the drawings, the same or corresponding sign refers to the same or corresponding part.

### DETAILED DESCRIPTION OF EMBODIMENTS

The preferred embodiments of the present disclosure will be described in more details with reference to the drawings. Although the drawings illustrate the preferred embodiments of the present disclosure, it should be appreciated that the present disclosure can be implemented in various manners and should not be limited to the embodiments explained herein. On the contrary, the embodiments are provided to make the present disclosure more thorough and complete and to fully convey the scope of the present disclosure to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The terms “one example embodiment” and “one embodiment” are to be read as “at least one example embodiment.” The term “a further embodiment” is to be read as “at least a further embodiment.” The terms “first”, “second” and so on can refer to same or different objects. The following text can also comprise other explicit and implicit definitions.

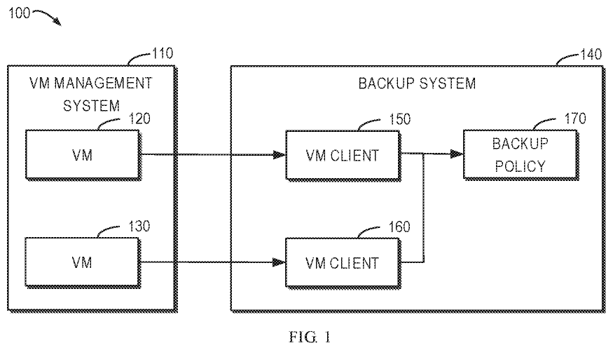

FIG. 1 shows a schematic view of a traditional virtual machine management environment 100. As shown in FIG. 1, the virtual machine management environment 100 comprises a virtual machine management system 110 and a backup system 140. The virtual machine management system 110 comprises one or more virtual machines, e.g. virtual machines 120 and 130. The virtual machines 120 and 130 can be used to run workloads for various businesses. The virtual machine management system 110 can be used to manage the virtual machines (VMs) 120 and 130 included therein. For example, the virtual machine management system 110 can provide an application interface (API) to create, read, update and remove the virtual machines 120, 130 and their properties. It should be understood that, for the illustration purpose only, FIG. 1 shows the virtual machine management system 110 comprises two virtual machines 120 and 130, and this should not be construed as suggesting any limitation to the number of virtual machines. In fact, the virtual machine management system 110 may comprise any number of virtual machines.

The backup system 140 comprises a backup policy 170. The backup policy 170 may specify an approach for backing up the virtual machines 120 and 130. In some embodiments, the backup policy 170 may be a logical group that defines when the virtual machines 120 and 130 are backed up, where the virtual machines 120 and 130 are backed up and which portions of the virtual machines 120 and 130 are backed up, and how long the backup of the virtual machines 120 and 130 will be retained.

In addition, to back up the virtual machines 120 and 130 in the backup system 140, the backup system 140 may create virtual machines clients 150 and 160 for the virtual machines 120 and 130, respectively. For example, the virtual machines 120 and 130 may be registered in the backup system 140 as the virtual machine clients 150 and 160, respectively. The backup system 140 may determine a backup policy for the virtual machines 120 and 130 based on the virtual machine clients 150 and 160. The virtual machine clients 150 and 160 may be characteristic information of the virtual machines 120 and 130 in the backup system 140. The characteristic information of the virtual machines 120 and 130 may be used to identify the virtual machines 120 and 130. For example, the characteristic information of the virtual machines 120 and 130 may comprise identification information of a virtual machine, a name of a virtual machine and/or a path of a virtual machine on the virtual machine management system 110, etc. It should be understood that, the above discussed characteristic information of a virtual machine is merely exemplary and not limiting, and is not intended to suggest any limitation to the scope of the present disclosure.

However, in the virtual machine management environment 100 shown in FIG. 1, only the virtual machines are backed up. A drawback of this approach lies in that only the virtual machine's disk images are backed up, but the applications in the virtual machine are not backed up. The application can be any application that can be installed and/or run in the virtual machine, which include but not limited to, database applications such as DB2, SQL Server, Oracle, etc. Because the disk image backup does not include the context of the application, e.g., the context of the application stored in a memory, an application in the virtual machine might still be in a destroyed status after the restoration, and thus failing to ensure that the virtual machine can be immediately used after the restoration. In this way, the application consistency cannot be ensured when backing up the virtual machine, i.e. the consistency between a status of the application when the application is being backed up and a status of the application after the application is restored cannot be guaranteed.

Traditionally approaches for backing up the application in the virtual machine include various drawbacks. One drawback is that because the application backup does not include an operating system environment of the application, the application needs to be restored in a similar operating system environment to the operating system environment in which the application is backed up. Another drawback is that, in order to back up the application, a user needs to manually install an application backup agent on the virtual machine. However, if the virtual machine management system comprises a large number of virtual machines, the manual installation of the application backup agents is difficult to be performed and is error-prone.

Example embodiments of the present disclosure propose a solution for managing a virtual machine. In various embodiments of the solution, a backup system determines whether a property of a virtual machine meets a predefined rule. The predefined rule is used to select a to-be-backed-up virtual machine. When the property of the virtual machine meets the predefined rule, the backup system determines an application client corresponding to an application in the virtual machine, the application client indicating characteristic information of the application in the backup system. The backup system determines, based on the application client, a backup policy for the application to back up the application. The backup policy specifies an approach for backing up the application in the backup system. In this way, the application in the virtual machine can be automatically backed up in the backup system while the application consistency can be ensured. Therefore, the efficiency and robustness of the backup system can be increased, and further the user experience can be improved.

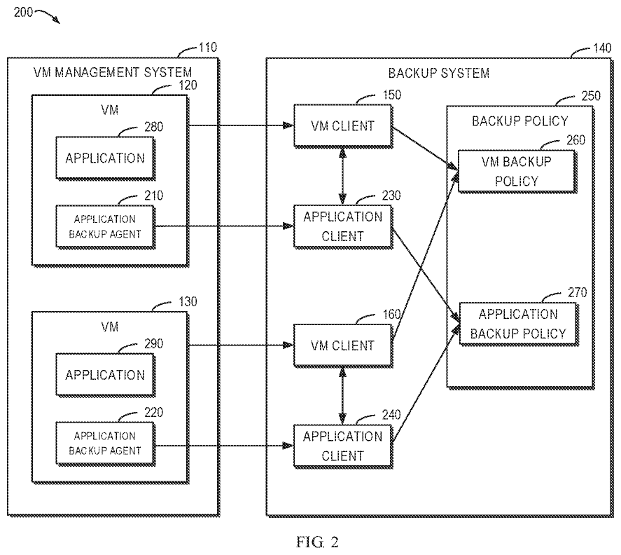

FIG. 2 shows a schematic view of an example virtual machine management environment 200 in which embodiments of the present disclosure can be implemented. It should be understood that, the virtual machine management environment 200 as shown in FIG. 2 is merely for illustration purposes, but does not suggest any limitation to the scope of the present disclosure. Embodiments of the present disclosure can be embodied in different structures.

Like the virtual machine management environment 100 shown in FIG. 1, the virtual machine management environment 200 comprises a virtual machine management system 110 and a backup system 140. The virtual machine management system 110 comprises virtual machines 120 and 130. The backup system 140 comprises virtual machine clients 150 and 160 corresponding to the virtual machines 120 and 130 respectively. As these elements in the virtual machine management environment 200 are similar to those in the virtual machine management environment 100, the descriptions thereof are omitted.

In addition to backing up the virtual machines 120 and 130 in the backup system 140 as described with reference to FIG. 1, in order to back up applications 280 and 290 in the virtual machines 120 and 130 in the backup system 140, the virtual machine management system 110 further comprises application backup agents 210 and 220 corresponding to the applications 280 and 290, respectively. The application backup agents 210 and 220 are installed in the virtual machines 120 and 130 respectively, for obtaining data of the applications 280 and 290 to back up the applications.

The backup system 140 may comprise application clients 230 and 240 for the application backup agents 210 and 220 respectively. For example, the application backup agents 210 and 220 may be registered in the backup system 140 as the application clients 230 and 240, respectively. The application clients 230 and 240 may be characteristic information of the applications 280 and 290 in the backup system 140. The characteristic information of the applications 280 and 290 may be used to identify the applications 280 and 290. For example, the characteristic information of the applications 280 and 290 may comprise identification information of an application, a name of an application, a name of a virtual machine in which an application is installed, an addressee of an application, etc. It should be understood that, the above discussed characteristic information of the application is merely exemplary and not limiting, and is not intended to suggest any limitation to the scope of the present disclosure.

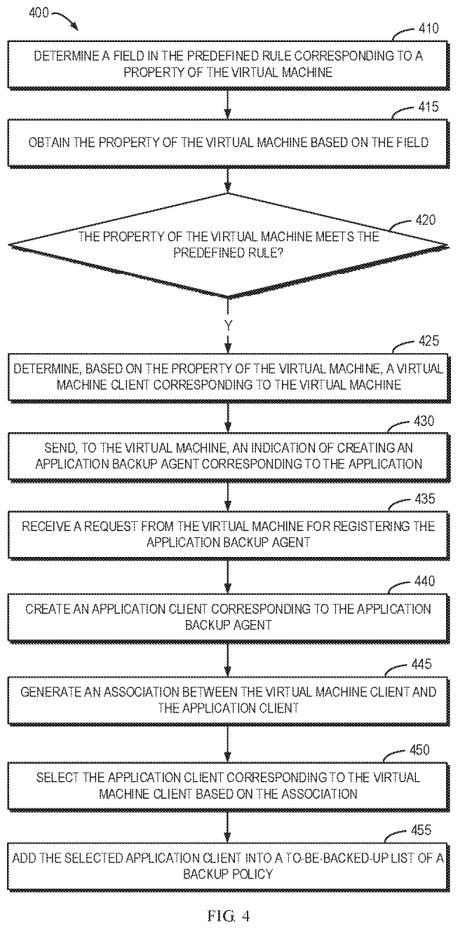

In some embodiments, for an application running on a virtual machine, the backup system 140 may establish an association between a virtual machine client for the virtual machine and an application client for the application. For example, the backup system 140 may establish an association between the virtual machine client 150 and the applicant client 230, and establish an association between the virtual machine client 160 and the application client 240. Thereby, the applications 280 and 290 can be backed up based on the associations as to be described in detail with reference to FIG. 4.

In addition, in the virtual machine management environment 200, the backup system 140 comprises a backup policy 250 instead of the backup policy 170 in the virtual machine management environment 100. The backup policy 250 may not only specify an approach for backing up the virtual machines 120 and 130 in the backup system 140, but also specify an approach for backing up the applications 280 and 290. In some embodiments, the backup policy 250 may comprise a virtual machine backup policy 260 for the virtual machines 120 and 130, as well as an application backup policy 270 for the applications 280 and 290.

For example, the backup policy 260 may define when the virtual machines 120 and 130 are backed up, where the virtual machines 120 and 130 are backed up and which portions of the virtual machines 120 and 130 are backed up, and how long the backup of these virtual machines will be retained. Similarly, the backup policy 270 may define when the applications 280 and 290 are backed up, where the applications 280 and 290 are backed up and which portions of the applications 280 and 290 are backed up, and how long the backup of these applications will be retained.

In some embodiments, the backup system 140 may provide a backup policy template for creating the backup policy 250, the backup policy template defining metadata needed to create the backup policy 250 for a specific type of application (e.g., database application). In this way, the backup policy 250 may be customized by using the backup policy template conveniently, without the need for a large amount of additional configuration. For example, the backup policy 250 may be generated based on the backup policy template, information (e.g. a name, identification information and/or address of the virtual machine management system) associated with the virtual machine management system as well as a predefined rule.

In addition, the predefined rule is a general rule associated with properties of a virtual machine. The predefined rule may be, for example, a user-created or system-defined rule, which may be implemented in any suitable format. For example, in some embodiments, the predefined rule may comprise executable code written by any suitable programming language and/or scripting language. Alternatively, the predefined rule may be described with formatted text such as extensible markup language (XML) text or plaintext.

The backup system 140 may evaluate the virtual machines 120, 130 and their applications 280, 290 using the predefined rule, and determine the virtual machine clients 150, 160 corresponding to the virtual machines 120, 130 and the application clients 230, 240 corresponding to the applications 280, 290 when properties of the virtual machines 120 and 130 meet the predefined rule. Further, the backup system 140 may determine the virtual machine backup policy 260 for the virtual machines 120, 130 based on the virtual machine clients 150, 160, and determine the application backup policy 270 for the applications 280, 290 based on the application clients 230 and 240. Thereby, the backup system 140 may back up the virtual machines 120 and 130 based on the virtual machine backup policy 260, and back up the applications 280 and 290 based on the application backup policy 270.

In this way, embodiments of the present disclosure may automatically select a to-be-backed-up virtual machine and its application, and assign backup policies to the selected virtual machine and its application. Thereby, the burden on the user for manually assigning backup policies to the virtual machine and its application can be eliminated, and an error rate in the backup system can be reduced significantly. Thus, the solution for managing a virtual machine of the present disclosure improves the usability and performance of the backup system.

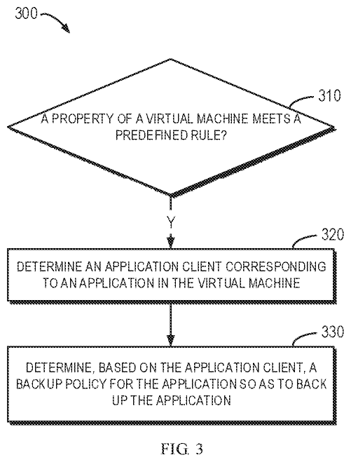

FIG. 3 shows a flowchart of an example method 300 for managing a virtual machine according to embodiments of the present disclosure. For example, the method 300 may be performed at the backup system 140 as shown in FIG. 2 or other appropriate system. For example, the method 300 may be performed by a computing device in the backup system 140 or other associated computing device. The computing device may be any appropriate computing device that is implemented in the backup system 140 in a centralized or distributed way, including but not limited to, a personal computer, a server, a client, a handheld or laptop device, a multiprocessor, a microprocessor, a set-top box, programmable consumer electronics, a network PC, a minicomputer, a mainframe computer system, a distributed cloud as well as combinations thereof.

It should be understood that, for the sake of description, acts performed by the computing device implementing the backup system 140 may also be described as being performed by the backup system 140 in this text. In addition, the method 300 may further comprise an additional step that is not shown and/or may omit a step that is shown, and the scope of the present disclosure is not limited in this regard.

At 310, the computing device determines whether properties of the virtual machines 120 and 130 meet a predefined rule, which is used to select a to-be-backed-up virtual machine. The properties of the virtual machines 120 and 130 may comprise: a virtual machine name, an access path, a resource pool, a virtual machine management system path, a data storage name, a data storage cluster name, a tag and/or other related properties.

For example, the virtual machine name may be names of the virtual machines 120 and 130. The access path may be a path in which the virtual machines 120 and 130 are located. The resource pool may be a location where the virtual machines 120 and 130 share their computing resource. The virtual machine management system path may be a path in which a virtual machine management system is located, the virtual machines 120 and 130 residing in the virtual machine management system. The data storage name may be a name of a data storage where data for and/or associated with the virtual machines 120 and 130 are located. The data storage cluster name may be a name of a data storage cluster where data for and/or associated with of the virtual machines 120 and 130 are located. The tag may be any key-value pair used to describe the virtual machines 120 and 130. For example, a tag “Tag=[System.Windows]” may be set to the virtual machine 120, which indicates the type of the tag is “System” and the value thereof is “Windows.” It should be understood that, the above discussed properties of the virtual machines are exemplary and not limiting, and are not intended to suggest any limitation to the scope of the present disclosure.

In some embodiments, the predefined rule may be a basic rule “Tag[System] contains Windows.” In addition, the predefined rule may be a compound rule derived from combining basic rules. For example, a logical operation such as “AND,” “OR” and “NOT” may be applied to the basic rules to obtain a compound rule. As an example, the predefined rule may be a compound rule “Tag[System] contains Windows AND Tag [App] contains SQL.” In addition, the predefined rule may be a compound rule obtained by combining compound rules.

As an example, the virtual machine 120 may have a property “Tag=[System.Windows],” and the predefined rule may be “Tag[System] contains Windows.” In this case, the computing device may determine that the property of the virtual machine 120 meets the predefined rule. When the computing device determines that properties of the virtual machines 120 and 130 meet the predefined rule, at 320, the computing device determines the application clients 230 and 240 corresponding to the applications 280 and 290 in the virtual machines 120 and 130, respectively. As described above, the application clients 230 and 240 may be characteristic information of the applications 280 and 290 in the computing device. The characteristic information of the applications 280 and 290 may be used to identify the applications 280 and 290 in the virtual machines 120 and 130.

In some embodiments, in order to back up the applications 280 and 290 in the virtual machines 120 and 130 in the computing device, the computing device may send, to the virtual machines 120 and 130 which meet the predefined rule, an indication of creating or installing the application backup agents 210 and 220 corresponding to the applications 280 and 290 respectively. As described above, the application backup agents 220 and 230 are used to obtain data of the applications 280 and 290 to back up these applications.

After receiving the indication, the virtual machines 120 and 130 will create the application backup agents 210 and 220 in the virtual machines 120 and 130. In some embodiments, the computing device may further obtain an installation status of the application backup agents 210 and 220 from the virtual machines 120 and 130, to determine whether the installation of the application backup agents 210 and 220 in the virtual machines 120 and 130 succeeds, fails or is in progress, etc.

In some embodiments, after the creation of the application backup agents 210 and 220 in the virtual machines 120 and 130 is completed, the application backup agents 210 and 220 may send, to the computing device, a request for registering the application backup agents 210 and 220. After receiving the request, the computing device may create the application clients 150 and 160 for the application backup agents 210 and 220, respectively.

Although in the example of FIG. 3, properties of the virtual machines 120 and 130 both meet the predefined rule, and the virtual machine clients 150, 160 and the application clients 230, 240 are created for the virtual machines 120,130 and their applications 280 and 290 respectively, it is noteworthy a virtual machine (not shown) whose property does not meet the predefined rule may also exist. When the computing device determines the property of a virtual machine does not meet the predefined rule, the computing device will not create any virtual machine client and application client corresponding to the virtual machine and its application, or remove the created virtual machine client and application client from the computing device. Accordingly, the computing device will not send an indication of creating an application backup agent to the virtual machine.

In this way, the virtual machine clients 150, 160 and the application clients 230, 240 corresponding to the virtual machines 120, 130 and their applications 280 and 290, respectively may be automatically added to, updated in and removed from the computing device.

At 330, the computing device determines the backup policy 270 for the applications 280 and 290 based on the application clients 230 and 240, to back up these applications. The backup policy 270 specifies an approach for backing up the applications 280 and 290 in the computing device. In some embodiments, the computing device may add the application clients 230 and 240 into a to-be-backed-up list of the backup policy 270. In addition, when the property of a virtual machine does not meet the predefined rule, because no application client is created in the computing device, the computing device will not back up the application in the virtual machine that does not meet the predefined rule.

In this way, the application backup policy may be automatically assigned to the application in the virtual machine, so that the robustness and usability of the backup system is improved.

FIG. 4 shows a flowchart of another example of a method 400 for managing a virtual machine according to embodiments of the present disclosure. For example, the method 400 may be performed at the backup system 140 as shown in FIG. 2 or another appropriate system. For example, the method 400 may be performed by a computing device in the backup system 140 or other associated computing device. The computing device may be any appropriate computing device that is implemented in the backup system 140 in a centralized or distributed way, including but not limited to, a personal computer, a server, a client, a handheld or laptop device, a multiprocessor, a microprocessor, a set-top box, programmable consumer electronics, a network PC, a minicomputer, a mainframe computer system, a distributed cloud as well as combinations thereof.

It should be understood that, for the sake of description, acts performed by the computing device implementing the backup system 140 may also be described as being performed by the backup system 140 in this text. In addition, the method 400 may further comprise an additional step that is not shown and/or may omit a step that is shown, and the scope of the present disclosure is not limited in this regard.

As described above, in some embodiments, the backup policy 250 is generated in the computing device based on a backup policy template, information associated with the virtual machine management system as well as a used-created or system-defined predefined rule. After the backup policy 250 is generated, the computing device may obtain, from the backup policy 250, a predefined rule used for selecting a to-be-backed-up virtual machine, e.g. “Tag[System] contains Windows.” At 410, the computing device determines a field in the predefined rule corresponding to a property of a virtual machine. For example, the computing device may determine a field in the predefined rule corresponding to a tag property of the virtual machine.

At 415, the computing device obtains the property of the virtual machine based on the field. For example, the computing device may obtain the tag property of the virtual machines 120 and 130, e.g., the virtual machines 120 and 130 may have a tag “Tag=[System.Windows].”

At 420, the computing device determines whether the property of the virtual machine meets the predefined rule. In some embodiments, the computing device may compare the property of the virtual machine with the predefined rule. For example, since a value of the type “System” in the tag property of both the virtual machines 120 and 130 contains “Windows,” the computing device may determine the property of the virtual machines 120 and 130 matches the predefined rule, in other words, determine the property of the virtual machines meets the predefined rule.

At 425, the computing device determines a virtual machine client corresponding to the virtual machine based on the property of the virtual machine. As described above, the virtual machine client indicates characteristic information of the virtual machine in the backup system. In some embodiments, when the computing device determines the property of the virtual machines 120 and 130 meets the predefined rule, the computing device may create the virtual machine clients 150 and 160 corresponding to the virtual machines 120 and 130, respectively.

Alternatively, when the created virtual machine clients 150 and 160 already exist in the computing device, the computing device may determine whether the property of the virtual machine has changed. For example, the virtual machine may notify the computing device via a virtual machine change event that the property of the virtual machine has changed. When the property of a certain virtual machine (e.g. the virtual machine 120) has changed, the computing device may obtain a changed property of the virtual machine and update the virtual machine client based on the changed property of the virtual machine.

As an example, suppose the virtual machine client 150 for the virtual machine 120 has been created in the computing device. At this point, the property of the virtual machine 120 changes from “Tag=[System.Windows]” to “Tag=[System.Linux].” The virtual machine 120 may notify the computing device via a virtual machine change event that the property of the virtual machine has changed. Because the property of the virtual machine no longer meets the predefined rule “Tag[System] contains Windows,” the computing device may remove the corresponding virtual machine client 150 of the virtual machine 120 based on the changed property of the virtual machine.

In addition, where a new virtual machine is added to the virtual machine management environment 200, the computing device may obtain a property of the new virtual machine. For example, the virtual machine may notify the computing device via a virtual machine add event that a new virtual machine has been added. The computing device may determine whether the property of the new virtual machine meets the predefined rule. When the computing device determines the property of the new virtual machine meets the predefined rule, the computing device creates a new virtual machine client corresponding to the new virtual machine. In this way, it can be ensured the virtual machine client 150 in the computing device is updated in real time when the virtual machine is changed.

At 430, the computing device sends, to the virtual machines 120 and 130 which meet the predefined rule, an indication of creating or installing the application backup agents 210 and 220 corresponding to the applications 280 and 290 in the virtual machines 120 and 130. As described above, the application backup agents 220 and 230 are used to obtain data of the applications 280 and 290 to back up these applications. In some embodiments, the computing device may obtain the type of a to-be-backed-up application, detect versions of an operating system in the virtual machines 120, 130 and the applications 280, 290 of the obtained type, and send, to the virtual machines 120, 130, an indication of installing appropriate application backup agents 210 and 220.

After receiving the indication, the virtual machines 120 and 130 may create the application backup agents 210 and 220 thereon. In some embodiments, the computing device may also store information related to the application backup agents 210 and 220, including but not limited to virtual machine identification information, an operating system name, an operating system version, an application name, an application version, application backup agent identification information and an application backup agent version, etc., so that the computing device may obtain the installation status of the application backup agents 210 and 220 through the stored information.

After the creation of the application backup agents 210 and 220 on the virtual machines 120 and 130 is completed, the application backup agents 210 and 220 may send, to the computing device, a request for registering the application backup agents 210 and 220. At 435, the computing device receives the request for registering the application backup agents 210 and 220 from these application backup agents in the virtual machines 120 and 130. After receiving the registration request, at 440, the computing device creates the application clients 230 and 240 for the application backup agents 210 and 220, respectively.

Like the virtual machine clients 150 and 160, when the created application clients 230 and 240 already exist in the computing device, the computing device may determine whether the property of the virtual machine has changed. When the property of a certain virtual machine (e.g. the virtual machine 120) has changed, the computing device may obtain the changed property of the virtual machine and update the application client based on the changed property of the virtual machine.

In addition, when a new virtual machine is added into the virtual machine management environment 200, the computing device may obtain a property of the new virtual machine, and determine whether the property of the new virtual machine meets the predefined rule. When the computing device determines the property of the new virtual machine meets the predefined rule, the computing device creates a new virtual machine client corresponding to the new virtual machine. In this way, it can be ensured the application client in the computing device is updated in real time after the virtual machine is changed.

At 445, for an application running in the virtual machine, the computing device may establish an association between a virtual machine client for the virtual machine and an application client for the application. For example, the computing device may establish an association between the virtual machine client 150 and the application client 230, and establish an association between the virtual machine client 160 and the application client 240. In this way, a backup policy may be assigned to the virtual machine and its application in association.

While backing up the virtual machine and its application, the computing device may obtain a property of the virtual machine based on the virtual machine client. For example, the computing device may obtain a property of the virtual machine 120 from the virtual machine client 150, and obtain a property of the virtual machine 130 from the virtual machine client 160. Alternatively, because the virtual machine client can identify the virtual machine, the computing device may obtain the property of the virtual machine stored in the computing device based on the virtual machine client. For example, the computing device may obtain the property of the virtual machine 120 stored in the computing device based on the virtual machine client 150, and obtain the property of the virtual machine 130 stored in the computing device based on the virtual machine client 160.

In some embodiments, the computing device may obtain properties of the virtual machines 120 and 130 when the backup policy 250 is triggered. For example, the backup policy 250 may specify the virtual machines 120 and 130 are backed up at midnight each day. In this case, the computing device may trigger the backup policy 250 at midnight each day, and obtain properties of the virtual machines 120 and 130. Then, the computing device may again determine whether the obtained properties of the virtual machine meet the predefined rule, in the above describe way of determining whether the property of the virtual machine meets the predefined rule. In this way, when the virtual machines 120 and 130 need to be backed up, the backup policy for the virtual machines 120 and 130 may be determined in real time, thus it can be ensured that the virtual machines 120 and 130 that currently meet the predefined rule are backed up.

When the properties of the virtual machines 120 and 130 meet the predefined rule, the computing device may add the virtual machine clients 150 and 160 into a to-be-backed-up list of the backup policy 260. In addition, at 450, the computing device selects the application clients 230 and 240 corresponding to the virtual machine clients 150 and 160 based on the respective associations between the virtual machine clients 150, 160 and the application clients 230, 240.

At 455, the computing device adds the selected application clients 230 and 240 into a to-be-backed-up list of the backup policy 270.

Table 1 shows improvements in virtual machine management as made by the virtual machine management technology according to embodiments of the present disclosure over the traditional virtual machine management technology.

TABLE 1

| | Present VM | Traditional VM | |
|---|---|---|---|
| | Management | Management | |
| Example | Technology | Technology | |
| Install application backup | ~1 minute | ~500 | minutes |
| agents on 100 VMs, and add | | | |
| VM clients and application | | | |
| clients into backup system | | | |
| Configure backup policies for | ~1 minute | ~20 | minutes |
| 100 VMs and 100 application | | | |
| clients | | | |
| Add, update and remove a | Instantly | ~10 | minutes |
| to-be-backed-up VM | | | |

As seen from Table 1, embodiments of the present disclosure automatically creates an application backup agent and an application client, which correspond to an application in the virtual machine, and assigns and updates an application backup policy to the application in the virtual machine. Therefore, the usability and performance of the backup system 140 is improved significantly in one or more embodiments of the present disclosure.

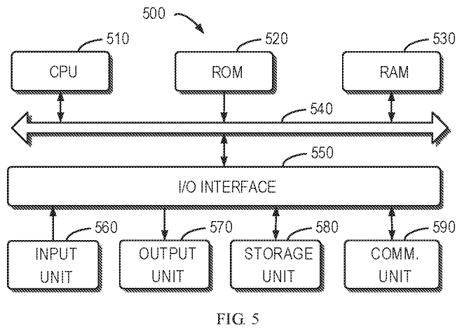

FIG. 5 schematically shows a block diagram of an example device 500 which is applicable to implement embodiments of the present disclosure. For example, the backup system 140 as shown in FIG. 1 may be implemented by the device 500. As depicted, the device 500 includes a central process unit (CPU) 510, which can execute various suitable actions and processing based on the computer program instructions stored in the read-only memory (ROM) 520 or computer program instructions loaded in the random-access memory (RAM) 530 from a storage unit 580. The RAM 530 can also store all kinds of programs and data required by the operations of the device 500. CPU 510, ROM 520 and RAM 530 are connected to each other via a bus 540. The input/output (I/O) interface 550 is also connected to the bus 540.

A plurality of components in the device 500 is connected to the I/O interface 550, including: an input unit 560, such as keyboard, mouse and the like; an output unit 570, e.g., various kinds of display and loudspeakers etc.; a storage unit 580, such as magnetic disk and optical disk etc.; and a communication unit 590, such as network card, modem, wireless transceiver and the like. The communication unit 590 allows the device 500 to exchange information/data with other devices via the computer network, such as Internet, and/or various telecommunication networks.

The above described each procedure and processing, such as the methods 300 and 400, can also be executed by the processing unit 510. For example, in some embodiments, the methods 300 and 400 can be implemented as a computer software program tangibly included in the machine-readable medium, e.g., the storage unit 580. In some embodiments, the computer program can be partially or fully loaded and/or mounted to the device 500 via ROM 520 and/or the communication unit 590. When the computer program is loaded to the RAM 530 and executed by the CPU 510, one or more steps of the above described methods 300 and 400 can be implemented.

The present disclosure can be a method, device, system and/or computer program product. The computer program product can include a computer-readable storage medium, on which the computer-readable program instructions for executing various aspects of the present disclosure are loaded.

The computer-readable storage medium can be a tangible device that maintains and stores instructions utilized by the instruction executing devices. The computer-readable storage medium can be, but not limited to, such as electrical storage device, magnetic storage device, optical storage device, electromagnetic storage device, semiconductor storage device or any appropriate combinations of the above. More specific examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to respective computing/processing device, or to an external computer or external storage via the network, such as the Internet, local area network, wide area network and/or wireless network. The network can include copper-transmitted cable, optical fiber transmission, wireless transmission, router, firewall, switch, gateway computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages consist of object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via the Internet using the Internet service provider). In some implementations, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to implementations of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions specified in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions contains an article of manufacture, including instructions for implementing various aspects of the functions/actions specified in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions specified in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or instructions, wherein the module and the part of program segment or instructions include one or more executable instructions for performing specified logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a dedicated hardware-based system for executing specified functions or actions, or by a combination of dedicated hardware and computer instructions.

Various implementations of the present disclosure have been described above and the above description is only exemplary rather than exhaustive and is not limited to the implementations of the present disclosure. Many modifications and alterations, without deviating from the scope and spirit of the explained various implementations, are obvious for those skilled in the art. The selection of terms in the text aims to best explain principles and actual applications of each implementation and technical improvements made in the market by each implementation, or enable other ordinary skilled in the art to understand implementations of the present disclosure.

1. A method for managing a virtual machine, comprising:
determining whether a property of a virtual machine meets a predefined rule, the predefined rule being used to select a to-be-backed-up virtual machine;
in response to the property of the virtual machine meeting the predefined rule, determining an application client corresponding to an application in the virtual machine, the application client indicating characteristic information of the application in a backup system; and
determining, based on the application client, a backup policy for the application to back up the application, the backup policy specifying an approach for backing up the application in the backup system.

2. The method of claim 1, wherein determining whether the property of a virtual machine meets a predefined rule comprises:
determining a field in the predefined rule corresponding to the property of the virtual machine;
obtaining the property of the virtual machine based on the field; and
determining whether the property of the virtual machine meets the predefined rule.

3. The method of claim 1, wherein determining the application client comprises:
sending, to the virtual machine, an indication of creating an application backup agent corresponding to the application, the application backup agent being used to obtain data of the application to back up the application;
receiving a request from the virtual machine to register the application backup agent; and
creating the application client corresponding to the application backup agent.

4. The method of claim 1, wherein determining the application client comprises:
determining whether the property of the virtual machine has changed; and
in response to determining that the property of the virtual machine has changed, updating the application client based on the changed property of the virtual machine.

5. (canceled)

6. The method of claim 20, wherein determining the backup policy based on the association comprises:
selecting, based on the association, the application client corresponding to the virtual machine client; and
adding the selected application client into a to-be-backed-up list of the backup policy.

7. The method of claim 1, wherein the property of the virtual machine comprises at least one of:
a virtual machine name, an access path, a resource pool, a virtual machine management system path, a data storage name, a data storage cluster name and a tag.

8. The method of claim 1, wherein characteristic information of the application comprises at least one of:
identification information of the application, a name of the application, a name of a virtual machine where the application is installed, and an address of the application.

9. The method of claim 20, wherein characteristic information of the virtual machine comprises at least one of:
identification information of the virtual machine, a name of the virtual machine, and a path of the virtual machine.

10. A device for managing a virtual machine, comprising:
at least one processing unit;
at least one memory, coupled to the at least one processing unit and storing instructions executed by the at least one processing unit, the instructions, when executed by the at least one processing unit, causing the device to perform acts comprising:
determining whether a property of the virtual machine meets a predefined rule, the predefined rule being used to select a to-be-backed-up virtual machine;
in response to the property of the virtual machine meeting the predefined rule, determining an application client corresponding to an application in the virtual machine, the application client indicating characteristic information of the application in a backup system; and
determining, based on the application client, a backup policy for the application to back up the application, the backup policy specifying an approach for backing up the application in the backup system.

11. The device of claim 10, wherein determining whether the property of a virtual machine meets a predefined rule comprises:
determining a field in the predefined rule corresponding to the property of the virtual machine;
obtaining the property of the virtual machine based on the field; and
determining whether the property of the virtual machine meets the predefined rule.

12. The device of claim 10, wherein determining the application client comprises:
sending, to the virtual machine, an indication of creating an application backup agent corresponding to the application, the application backup agent being used to obtain data of the application to back up the application;
receiving a request from the virtual machine to register the application backup agent; and
creating the application client corresponding to the application backup agent.

13. The device of claim 10, wherein determining the application client comprises:
determining whether the property of the virtual machine has changed; and
in response to determining that the property of the virtual machine has changed, updating the application client based on the changed property of the virtual machine.

14. (canceled)

15. (canceled)

16. The device of claim 10, wherein the property of the virtual machine comprises at least one of:
a virtual machine name, an access path, a resource pool, a virtual machine management system path, a data storage name, a data storage cluster name and a tag.

17. The device of claim 10, wherein characteristic information of the application comprises at least one of:
identification information of the application, a name of the application, a name of a virtual machine where the application is installed, and an address of the application.

18. (canceled)

19. A computer program product, tangibly stored on a non-transient computer readable medium and comprising machine executable instructions, the machine executable instructions, when executed, cause a machine to implement a method, the method comprises:
determining, based on a property of the virtual machine, a virtual machine client corresponding to the virtual machine, the virtual machine client indicating characteristic information of the virtual machine in a backup system;
generating an association between the virtual machine client and the application client; and
determining the backup policy based on the association.

20. A method for managing a virtual machine, comprising:
determining, based on a property of the virtual machine, a virtual machine client corresponding to the virtual machine, the virtual machine client indicating characteristic information of the virtual machine in a backup system;
generating an association between the virtual machine client and the application client; and
determining the backup policy based on the association.
